(19) United States
(12) Patent Application Publication
(10) Pub. No.: US 2025/0292948 A1
(43) Pub. Date: Sep. 18, 2025

(54) REACTOR

(71) Applicant: HONDA MOTOR CO., LTD., Tokyo (JP)

(72) Inventor: Taro MATOBA, Saitama (JP)

(21) Appl. No.: 19/044,749

(22) Filed: Feb. 4, 2025

(30) Foreign Application Priority Data
Mar. 12, 2024 (JP) 2024-038366

(51) Int. Cl. H01F 27/29; H02G 5/02

(52) U.S. Cl. CPC H01F 27/29; H02G 5/02

(57) ABSTRACT

A reactor includes a coil provided for every phase aligned in a predetermined phase alignment direction, and a first bus bar extending in the phase alignment direction. Each coil includes a first terminal which is a portion of a flat wire-shaped part of the coil. A normal direction of the first terminal is a phase alignment direction. The first bus bar includes a connection portion for every coil. The normal direction of each connection portion is the phase alignment direction. For each of the connection portions of the first bus bar, the connection portion contacts in the phase alignment direction against the first terminal of the coil corresponding to said connection portion.

This application is based on and claims the benefit of priority from Japanese Patent Application No. 2024-038366, filed on 12 Mar. 2024, the content of which is incorporated herein by reference.

### BACKGROUND OF THE INVENTION

### Field of the Invention

The present invention relates to a reactor which includes a plurality of coils.

### Related Art

Among reactors, there are those which include a plurality of coils and a bus bar electrically connected to these coils.

Patent Document 1: Japanese Unexamined Patent Application, Publication No. 2018-081963

### SUMMARY OF THE INVENTION

The present inventors have focused on the point that it is preferable for the assembly workability to be as good as possible for such a reactor. The present invention has been made taking account of the above situation, and has an object of improving the assembly workability of a reactor.

The present inventors have found that the assembly workability of the reactor improves when modifying the shape of a portion of a bus bar electrically connected to the terminal of each coil, and the shape of a terminal of each coil, thereby arriving at the present invention. The present invention provides the reactor of the following first to fourth aspects.

According to a first aspect of the present invention, a reactor includes a coil provided for every phase aligned in a predetermined phase alignment direction, and a first bus bar extending in the phase alignment direction, in which each of the coils includes a first terminal which is a portion of a flat wire-shaped part of the coil, and a normal direction of the first terminal is the phase alignment direction, the first bus bar includes a connection portion for each of the coils, and a normal direction of each of the connection portions is the phase alignment direction, and for each of the connection portions of the first bus bar, the connection portion contacts in the phase alignment direction against the first terminal of the coil corresponding to said connection portion.

According to the present configuration, by pressing the first bus bar in the phase alignment direction, it is possible to electrically connect each connection portion of this first bus bar to the first terminal of a coil corresponding to a related one of the connection portions. Based on these matters, it is possible to improve the assembly workability of the reactor.

According to a second aspect of the present invention, in the reactor as described in the first aspect, the phase alignment direction is a horizontal direction, the coils include, for each of the phases, a first coil and a second coil arranged in a horizontal direction which is orthogonal to the phase alignment direction, a first coil and a second coil being connected electrically to each other in parallel, for each of the phases, a portion of the first coil closer to the first terminal and a portion of the second coil closer to the first terminal respectively extend upwards, and then extend in the horizontal direction to directly above the first coil, whereby the first terminal of the first coil and the first terminal of the second coil are positioned directly above the first coil, and wherein the first bus bar is electrically connected to the first terminal of the first coil and the first terminal of the second coil, directly above each of the first coil.

According to the present configuration, for each of the phases, the first terminal of the first coil and the first terminal of the second coil are gathered directly above the first coil. Based on this, directly above the first coil of each phase, the first bus bar can be electrically connected to the first terminal of this first coil and the first terminal of the second coil.

According to a third aspect of the present invention, the reactor as described in the second aspect further includes a second bus bar for each of the phases, in which each of the coils includes a second terminal, for each of the phases, a portion of the first coil closer to the second terminal and a portion of the second coil closer to the second terminal respectively extend upwards, and then extend in a horizontal direction to directly above the second coil, whereby a second terminal of the first coil and a second terminal of the second coil are positioned directly above the second coil, and for each of the phases, the second bus bar is electrically connected directly above the second coil to the second terminal of said second coil and the second terminal of the first coil.

According to the present configuration, for each phase, the second terminal of the first coil and the second terminal of the second coil are gathered directly above the second coil. Based on this, directly above the second coil of every phase, the second bus bar can be electrically connected to the second terminal of this second coil and the second terminal of the first coil.

According to a fourth aspect of the present invention, in the reactor as described in the second or third aspect, each of the first coils and each of the second coils are all an identical shape.

According to the present configuration, it is possible to reduce the types of members in the reactor and simply configure the reactor, by establishing each of the first coils and each of the second coils in identical shapes.

As stated above, according to the configuration of the first aspect, it is possible to improve the assembly workability of the reactor. Furthermore, according to the configurations of the second to fourth aspects which cite the first aspect, each additional effect can be obtained.

### BRIEF DESCRIPTION OF THE DRAWINGS

FIG. 1 is a perspective view showing a reactor according to a first embodiment;

FIG. 2 is a plan view showing a reactor;

FIG. 3 is a circuit diagram showing a circuit including the reactor;

FIG. 4 is a plan view showing an initial stage during assembly of the reactor;

FIG. 5 is a perspective view showing this initial stage;

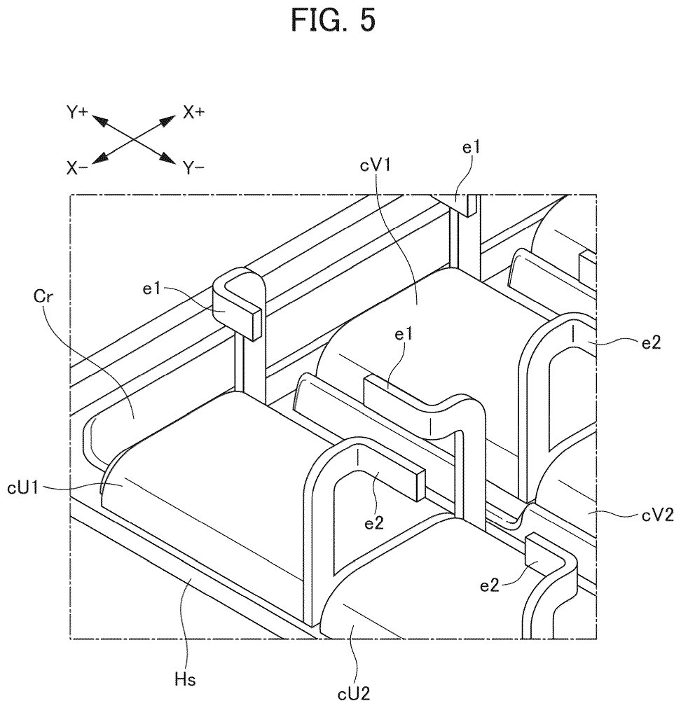

FIG. 6 is a plan view showing a stage subsequent to FIG. 4 during the assembly;

FIG. 7 is a perspective view showing coils in a reactor according to a comparative embodiment; and

FIG. 8 is a plan view showing a state during assembly of the reactor.

### DETAILED DESCRIPTION OF THE INVENTION

Hereinafter, embodiments of the present invention will be described while referencing the drawings. However, the present invention is not to be limited in any way to the following embodiments, and can be realize by modifying as appropriate within a scope not departing from the gist of the present invention.

### First Embodiment

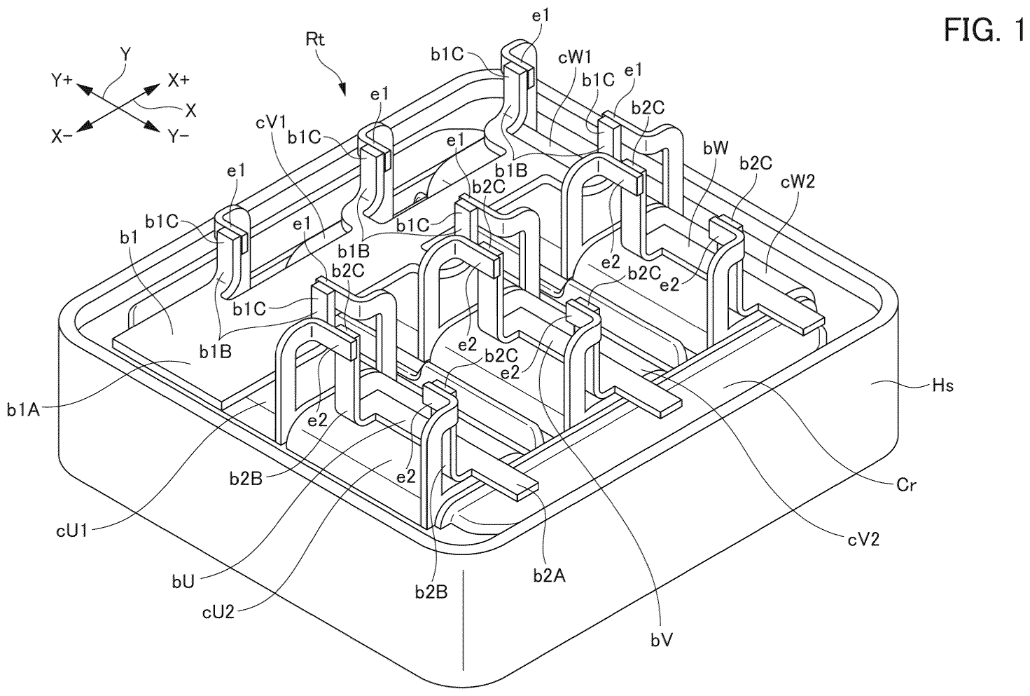

As shown in FIG. 1, a reactor Rt includes a housing Hs, a core Cr, six coils cU1 to cW2, a first bus bar B1, and three second bus bars bU, bV and bW.

The six coils cU1 to cW2 consist of a U-phase first coil cU1, a U-phase second coil cU2, a V-phase first coil cV1, a V-phase second coil cV2, a W-phase first coil cW1, and a W-phase second coil cW2.

Hereinafter, the U-phase first coil cU1 and the U-phase second coil cU2 are referred to as “U-phase coils cU1, cU2”. In addition, the V-phase first coil cV1 and the V-phase second coil cV2 are referred to as “V-phase coils cV1, cV2”. In addition, the W-phase first coil cW1 and the W-phase second coil cW2 are referred to as “W-phase coils cW1, cW2”. In addition, the U-phase first coil cU1, the V-phase first coil cV1 and the W-phase first coil cW1 are referred to as “first coils cU1, cV1, cW1”. In addition, the U-phase second coil cU2, the V-phase second coil cV2 and the W-phase second coil cW2 are referred to as “second coils cU2, cV2, cW2”. In addition, for each of the coils cU1 to cW2, one terminal is referred to as “first terminal e1”, and the other terminal is referred to as “second terminal e2”.

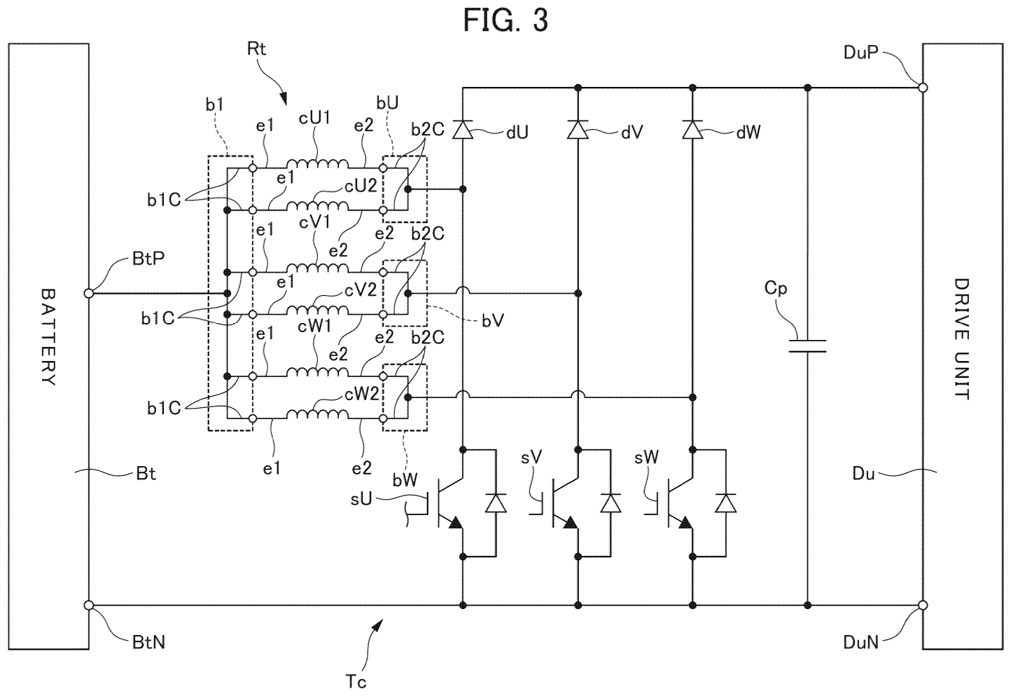

As shown in FIG. 3, the reactor Rt constitutes a part of a 3-phase boost chopper Tc, for example. This 3-phase boost chopper Tc boosts the voltage from a battery Bt, and supplies this to a drive unit Du, for example. In addition to the above-mentioned reactor Rt, the 3-phase boost chopper Tc includes three semiconductor switches sU, sV and sW, three diodes dU, dV and dW, and a smoothing capacitor Cp. The three semiconductor switches sU, sV and sW consist of a U-phase switch sU, a V-phase switch sV and a W-phase switch sW. The three diodes dU, dV and dW consist of a U-phase diode dU, a V-phase diode dV and a W-phase diode dW.

A plus terminal BtP of the battery Bt is electrically connected to the first terminal e1 of each of the six coils cU1 to cW2 via the first bus bar b1. The six coils cU1 to cW2 are thereby respectively electrically connected to each other in parallel.

The second terminal e2 of each of the two U-phase coils cU1, cU2 is electrically connected to the anode terminal of the U-phase diode dU, and electrically connected to the plus terminal of the U-phase switch sU, via the U-phase bus bar bU. The second terminal e2 of each of the two V-phase coils cU1, cV2 is electrically connected to the anode terminal of the V-phase diode dV, and electrically connected to the plus terminal of the V-phase switch sV, via a V-phase bus bar bV. The second terminal e2 of each of the two W-phase coils cW1, cW2 is electrically connected to the anode terminal of the W-phase diode dW, and electrically connected to the plus terminal of the W-phase switch sW, via a W-phase bus bar bW.

The cathode terminal of each of the three diodes dU, dV and dW is electrically connected to the plus terminal of the smoothing capacitor Cp, and the plus terminal DuP of the drive unit Du. The minus terminal of each of the three switches sU, sV and sW is electrically connected to the minus terminal BtN of the battery Bt, the minus terminal of the smoothing capacitor Cp, and the minus terminal DuN of the drive unit Du.

Hereinafter, as shown in FIG. 1, two predetermined directions orthogonal to each other within a horizontal plane are referred to as “X direction” and “Y direction”. In addition, one side of the X direction is referred to as “X− side”, and the opposite side thereto is referred to as “X+ side”. Furthermore, one side in the Y direction is referred to as “Y− side”, and the opposite side thereto is referred to as “Y+ side”.

The core Cr is a member of a magnetic material, and is formed to be divided in two at the middle part in the Y direction, for example. Each of the six coils cU1 to cW2 is fit onto the core Cr. The three first coils cU1, cV1 and cW1 are thereby aligned in the X direction. In addition, the three second coils cU2, cV2 and cW2 are aligned in the X direction more to the Y− side than the three first coils cU1, cV1 and cW1. In other words, the three phases of the U-phase, V-phase and W-phase are aligned in the X direction. Therefore, “X direction” may be replaced with “phase alignment direction”. The housing Hs stores this core Cr and six coils cU1 to cW2 inside thereof.

All of the respective six coils cU1 to cW2 are the same shape. Each of these six coils cU1 to cW2 is configured mainly of a flat wire-shaped conductor which extends in a spiral. In each of the six coils cU1 to cW2, the first terminal e1 is provided to one end part of this flat wire-shaped conductor, and a second terminal e2 is provided to the other end part of this rectangular conductor.

As shown in FIG. 1, in each of the three first coils cU1, cV1 and cW1, a portion on the first terminal el side extends upwards, and then extends in the horizontal direction to directly above the first coils cU1, cV1 and cW1. On the other hand, a portion on the first terminal e1 side of each of the second coils cU2, cV2 and cW2 extends upwards, and then extends in the horizontal direction to directly above the first coils cU1, cV1 and cW1 of the same phase.

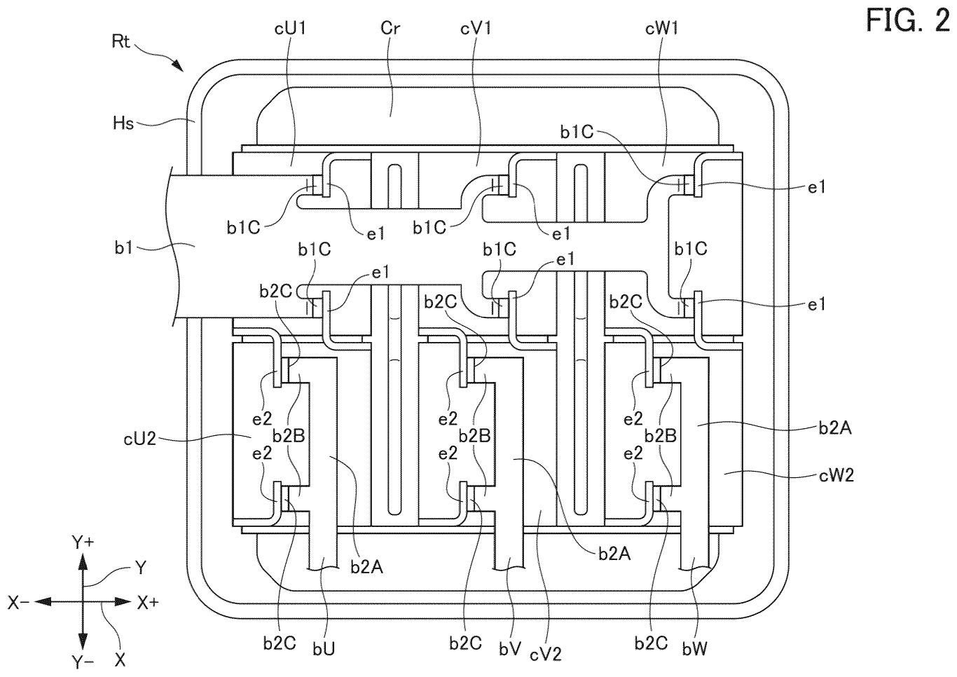

Based on this, as shown in FIG. 2, in each of the three phases, the first terminal e1 of the first coils cU1, cV1 and cW1, and the first terminal e1 of the second coils cU2, cV2 and cW2 are positioned directly above the first coils cU1, cV1 and cW1. The normal direction of the first terminal e1 of each of the three first coils cU1, cV1 and cW1 and the normal direction of the first terminal e1 of each of the three second coils cU2, cV2 and cW2 are all the X direction.

As shown in FIG. 1, a portion on the second terminal e2 side of each of the three first coils cU1, cV1 and cW1 extends upwards, and then extends in the horizontal direction to directly above the second coils cU2, cV2 and cW2 of the same phase. On the other hand, a portion on the second terminal e2 side of each of the second coils cU2, cV2 and cW2 extends upwards, and then extends in the horizontal direction to directly above the related one of the second coils cU2, cV2 and cW2.

Based on this, as shown in FIG. 2, in each of the three phases, the second terminals e2 of the first coils cU1, cV1 and cW1, and the second terminals e2 of the second coils cU2, cV2 and cW2 are positioned directly above the second coils cU2, cV2 and cW2. The normal direction of the second terminal e2 of each of the three first coils cU1, cV1 and cW1, and the normal direction of the second terminal e2 of each of the three second coils cU2, cV2 and cW2 are all the X direction.

As shown in FIG. 1, the first bus bar b1 is provided so as to bridge directly above the three first coils cU1, cV1 and cW1. The first bus bar b1 is a conductive member, and includes a base b1A and six protrusions b1B. The base b1A extends in the X direction. Each of the protrusions b1B is a flat wire-shaped part protruding upwards from the base b1A. The upper end part of each protrusion b1B constitutes a connection portion b1C. Based on this, the first bus bar b1 has six of the connection portions b1C. The normal direction of each of the connection portions b1C is the X direction.

Each of the six connection portions b1C of the first bus bar b1 contacts the first terminal e1 of the coils cU1 to cW2 corresponding to the related one of the connection portions b1C from the X− side to the X+ side. In other words, for example, a predetermined connection portion b1C of the first bus bar b1 contacts the first terminal e1 of the U-phase first coil cU1 from the X− side to the X+ side. In addition, for example, another connection portion b1C of the first bus bar b1 contacts the first terminal e1 of the U-phase second coil cU2 from the X− side to the X+ side.

The U-phase bus bar bU is provided directly above the U-phase second coil cU2. The U-phase bus bar bU is a conductive member, and includes a base b2A and two protrusions b2B. The base b2A extends in the Y direction. Each of the protrusions b2B is a flat wire-shaped part that protrudes upwards from the base b2A. The upper end part of each of the protrusions b2B constitutes a connection portion b2C. Based on this, the U-phase bus bar bU has two of the connection portions b2C. The normal direction of each of the connection portions b2C is the X direction.

Each of the two connection portions b2C of the U-phase bus bar bU contacts the second terminal e2 of the U-phase coils cU1 and cU2 corresponding to the related one of these connection portions b2C from the X+ side to the X− side. In other words, one of the connection portions b2C of the U-phase bus bar bU contacts the second terminal e2 of the U-phase first coil cU1 from the X+ side to the X− side. In addition, the other connection portion b2C of the U-phase bus bar bU contacts the second terminal e2 of the U-phase second coil cU2 from the X+ side to the X− side.

The description for the V-phase bus bar bV is similar to the description for the U-phase bus bar bU shown above by replacing the terms of “U-phase” with “V-phase”, and replacing the symbol with a corresponding one. In addition, the description of the W-phase bus bar bW is similar to the description of the U-phase bus bar bU shown above by replacing the terms of “U-phase” with “W-phase”, and replacing the symbol with a corresponding one.

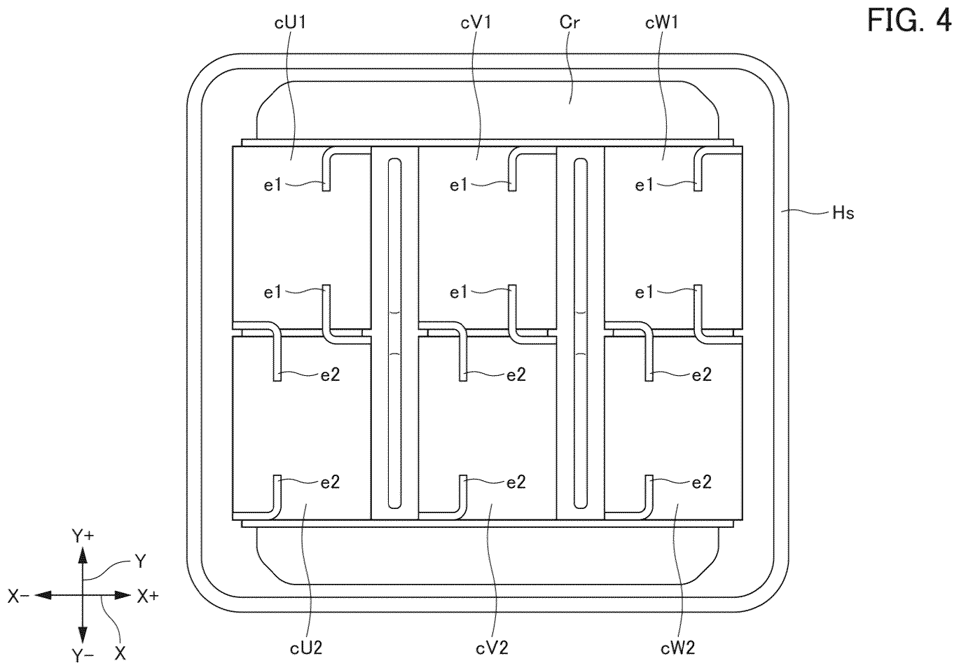

Next, a manufacturing method of the reactor Rt shown above will be described. First, as shown in FIG. 4, each of the six coils cU1 to cW2 is fit onto a predetermined position of the core Cr. The first terminals e1 of the first coils cU1, cV1 and cW1 and the first terminals e1 of the second coils cU2, cV2 and cW2 of each of the three phases are thereby arranged directly above the first coils cU1, cV1 and cW1. In addition, the second terminals e2 of the first coils cU1, cV1 and cW1, and the second terminals e2 of the second coils cU2, cV2 and cW2 of each of the three phases are arranged directly above the second coils cU2, cV2 and cW2.

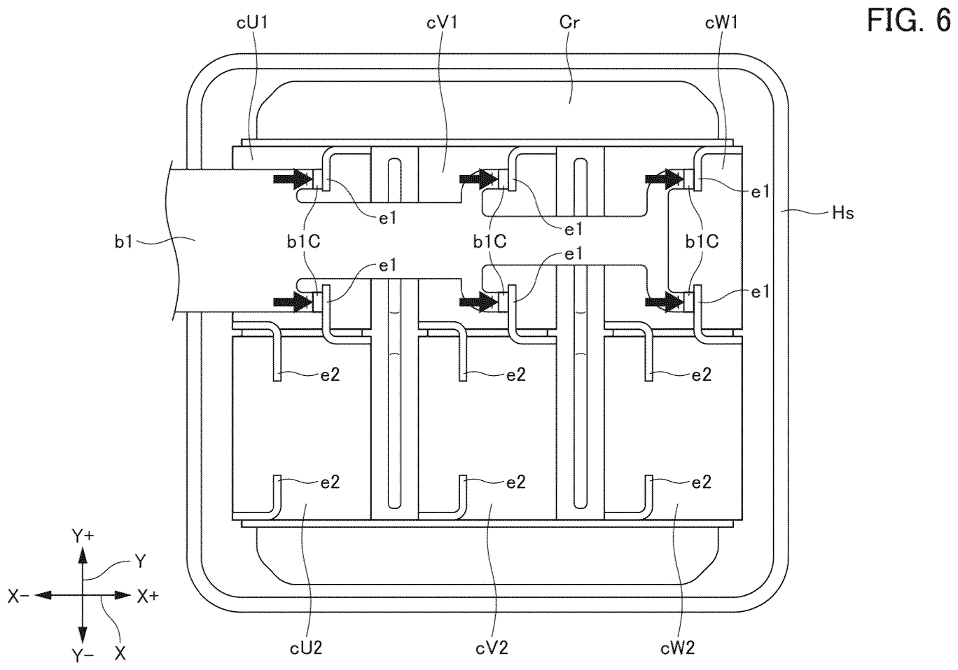

Next, as shown in FIG. 6, the first bus bar b1 is arranged so as to bridge directly above the three first coils cU1, cV1 and cW1. At this time, each of the connection portions b1C of the first bus bar b1 configures so as to be arranged more to the X− side than the first terminal e1 of the coils cU1 to cW2 corresponding to the related one of the connection portions b1C. From this state, the first bus bar b1 is made to move from the X− side to the X+ side. Each of the six connection portions b1C of the first bus bar b1 is thereby made to contact the first terminal e1 of the coils cU1 to cW2 corresponding to a related one of the connection portions b1C. The first bus bar b1 is thereby electrically connected to the first terminal e1 of each of the six coils cU1 to cW2. In this state, the first bus bar b1 is fixed to the housing Hs, etc., and each of the six connection portion b1C of the first bus bar b1 is welded to the first terminal e1 of the coils cU1 to cW2 corresponding to a related one of the connection portions b1C.

From this state, as shown in FIG. 2, each of the three second bus bars bU, bV and bW is attached. In other words, the U-phase bus bar bU is arranged directly above the U-phase second coil cU2. At this time, each of the connection portions b2C of the U-phase bus bars bU is configured so as to be arranged more to the X+ side than the second terminals e2 of the U-phase coils cU1 and cU2 corresponding to a related one of the connection portions b2C. From this state, the U-phase bus bar bU is made to move to the X-side. Each of the two connection portions b2C of the U-phase bus bar bU is thereby made to contact a second terminal e2 of the U-phase coil cU1 and cU2 corresponding to a related one of the connection portions b2C. The U-phase bus bar bU is thereby electrically connected to the second terminals e2 of each of the two U-phase coils cU1 and cU2. In this state, the U-phase bus bar bU is fixed to the housing Hs, etc., and each of two connection portions b2C of the U-phase bus bar bU is welded to the second terminal e2 of the U-phase coils cU1 and cU2 corresponding to a related one of the connection portions b2C.

The description for attachment of the V-phase bus bar bV is similar to the description for attachment of the U-phase bus bar bU shown above by replacing the term of “U-phase” with “V-phase”, and replacing the symbol with a corresponding one. In addition, the description for the attachment of the W-phase bus bar bW is similar to the description for attachment of the U-phase bus bar bU shown above by replacing the term of “U-phase” with “W-phase”, and replacing the symbol with a corresponding one.

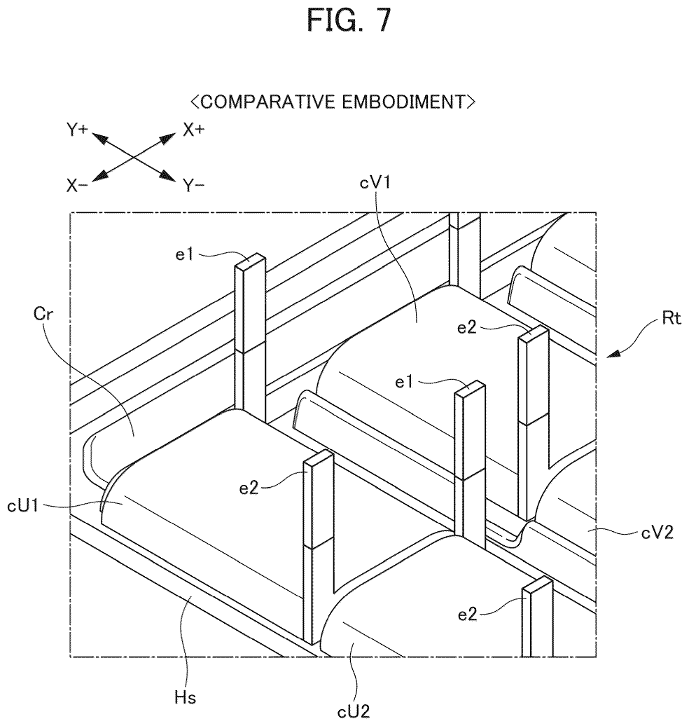

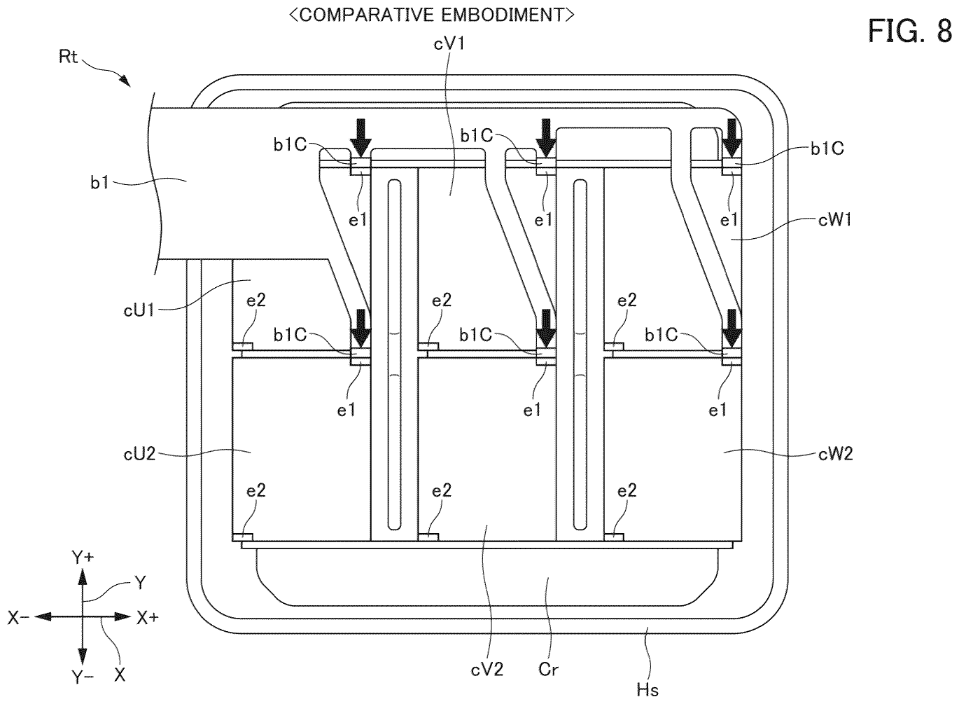

Hereinafter, an embodiment achieved by changing the form of the present embodiment as follows will be referred to as a Comparative Example. In other words, in this Comparative Example, the normal directions of the first terminals e1 of the respective six coils cU1 to cW2 are not the X direction, but rather are all the Y direction, as shown in FIG. 7. Based on this, as shown in FIG. 8, the normal direction of each of the six connection portions b1C of the first bus bar b1 is also not the X direction, but rather the Y direction. Based on this, each of the six connection portions b1C of the first bus bar b1 contacts the first terminal e1 of the coils cU1 to cW2 corresponding to a related one of the connection portions b1C from the Y+ side to the Y− side.

The configuration and effects of the present embodiment will be summarized while comparing with the comparative embodiment.

In the comparative embodiment shown in FIG. 8, normal direction of the first terminal e1 of each of the six coils cU1 to cW2 and the normal direction of each of the six connection portions b1C of the first bus bar b1 are the Y direction, i.e. direction orthogonal to the phase alignment direction. For this reason, it is necessary to make each of the six connection portions b1C of the first bus bar b1 contact the first terminal e1 of the coils cU1 to cW2 corresponding to a related one of the connection portion b1C by making the first bus bar b1 move in this direction orthogonal to the phase alignment direction. Based on this, the operation to make contact is likely to become difficult.

In this regard, with the present embodiment, the normal direction of the first terminal e1 of each of the six coils cU1 to cW2, and the normal direction of each of the six connection portions b1C of the first bus bar b1 are the X direction, i.e. phase alignment direction, as shown in FIG. 6. For this reason, by making the first bus bar b1 move in this phase alignment direction, each of the six connection portions b1C of the first bus bar b1 can be made to contact the first terminal e1 of the coils cU1 to cW2 corresponding to a related one of the connection portions b1C. Based on this, it is possible to improve the assembly workability of the reactor Rt.

With the present embodiment, in each phase, the first terminals e1 of the first coils cU1, cV1 and cW1 and the first terminals e1 of the second coils cU2, cV2 and cW2 are gathered directly above the first coils cU1, cV1 and cW1, as shown in FIG. 6. Therefore, for each of the phases, directly above the first coils cU1, cV1 and cW1, the first bus bar b1 can be electrically connected with the first terminal e1 of a related one of the first coils cU1, cV1 and cW1 and to the first terminal e1 of a related one of the second coils cU2, cV2 and cW2. Based on this, the area of the steel plate material necessary in cutting out of the first bus bar b1 can be reduced in amount compared to the first bus bar b1 of the comparative embodiment shown in FIG. 7. This leads to an improvement in yield.

In the present embodiment, as shown in FIG. 2, in each phase, the second terminals e2 of the first coils cU1, cV1 and cW1 and the second terminals e2 of the second coils cU2, cV2 and cW2 are gathered directly above the second coils cU2, cV2 and cW2. Thereby, for each of the three phases, directly above the second coils cU2, cV2 and cW2, the second bus bars bU, bV and bW are electrically connected to the second terminals e2 of these second coils cU2, cV2 and cW2 and to the second terminals e2 of the first coils cU1, cV1 and cW1.

Each of the first coils cU1, cV1 and cW1 and each of the second coils cU2, cV2 and cW2 shown in FIG. 1 are all the same shape. Therefore, the types of components in the reactor Rt can be reduced, and thus the reactor Rt can be simply configured.

### Other Embodiments

The embodiment shown above can be modified as follows, for example. The reactor Rt shown in FIG. 1 may constitute a part of a circuit other than the 3-phase boost chopper Tc shown in FIG. 3. In the reactor Rt shown in FIG. 1, each of the three phases may only include the first coils cU1, cV1 and cW1, and may not include the second coils cU2, cV2 and cW2. It should be noted that, in this case, there may be only three of the connection portions b1C of the first bus bar b1, and there may be only one connection portion b2C for each of the three second bus bars bU, bV and bW.

### EXPLANATION OF REFERENCE NUMERALS

b1 first bus bar
b1C connection portion of first bus bar
bU U-phase bus bar (second bus bar)
bV V-phase bus bar (second bus bar)
bW W-phase bus bar (second bus bar)
cU1 U-phase first coil (coil) (first coil)
cU2 U-phase second coil (coil) (second coil)
cV1 V-phase first coil (coil) (first coil)
cV2 V-phase second coil (coil) (second coil)
cW1 W-phase first coil (coil) (first coil)
cW2 W-phase second coil (coil) (second coil)
e1 first terminal of coil
e2 second terminal of coil
Rt reactor
X phase alignment direction
Y Horizontal direction orthogonal to phase alignment direction

What is claimed is:

1. A reactor comprising a coil provided for every phase aligned in a predetermined phase alignment direction, and a first bus bar extending in the phase alignment direction,
wherein each of the coils includes a first terminal which is a portion of a flat wire-shaped part of the coil, and a normal direction of the first terminal is the phase alignment direction,
wherein the first bus bar includes a connection portion for each of the coils, and a normal direction of each of the connection portions is the phase alignment direction, and
wherein, for each of the connection portions of the first bus bar, the connection portion contacts in the phase alignment direction against the first terminal of the coil corresponding to said connection portion.

2. The reactor according to claim 1, wherein the phase alignment direction is a horizontal direction,
wherein the coils include, for each of the phases, a first coil and a second coil arranged in a horizontal direction which is orthogonal to the phase alignment direction, a first coil and a second coil being connected electrically to each other in parallel,
wherein, for each of the phases, a portion of the first coil closer to the first terminal and a portion of the second coil closer to the first terminal respectively extend upwards, and then extend in the horizontal direction to directly above the first coil, whereby the first terminal of the first coil and the first terminal of the second coil are positioned directly above the first coil, and
wherein the first bus bar is electrically connected to the first terminal of the first coil and the first terminal of the second coil, directly above each of the first coil.

3. The reactor according to claim 2, further comprising a second bus bar for each of the phases,
wherein the coil includes a second terminal,
wherein, for each of the phases, a portion of the first coil closer to the second terminal and a portion of the second coil closer to the second terminal respectively extend upwards, and then extend in a horizontal direction to directly above the second coil, whereby a second terminal of the first coil and a second terminal of the second coil are positioned directly above the second coil, and
wherein, for each of the phases, the second bus bar is electrically connected directly above the second coil to the second terminal of said second coil and the second terminal of the first coil.

4. The reactor according to claim 2, wherein each of the first coils and each of the second coils are all an identical shape.
